(19) United States
(12) Patent Application Publication
(10) Pub. No.: US 2023/0286499 A1
(43) Pub. Date: Sep. 14, 2023

(54) COLLISION AVOIDANCE WARNING SYSTEM AND METHOD FOR CONTROLLING THE SAME

(71) Applicant: HL KLEMOVE CORP., Incheon (KR)

(72) Inventor: Yeonjoon HAN, Seoul (KR)

(21) Appl. No.: 18/118,137

(22) Filed: Mar. 7, 2023

(30) Foreign Application Priority Data
Mar. 10, 2022 (KR) 10-2022-0029805

(51) Int. Cl. B60W 30/095; B60W 50/14

(52) U.S. Cl. CPC B60W 30/0956; B60W 50/14; B60W 2556/45; B60W 2554/80; B60W 2050/143

(57) ABSTRACT

Disclosed are a collision avoidance warning system and a method for controlling the same, and the collision avoidance warning system includes: a first wireless transceiving device provided in a first movement means; a second wireless transceiving device provided in a second movement means and connected to the first wireless transceiving device by wireless network communication; a control unit provide in the first wireless transceiving device, and deriving a collision risk level of the first movement means and the second movement means; and an alarm transmission unit transmitting a warning alarm to a user of the first movement means according to the collision risk level derived by the control unit.

### CROSS-REFERENCE TO RELATED APPLICATION

This application claims benefit and priority to Korean Patent Application No. 10-2022-0029805, filed on Mar. 10, 2022, with the Korean Intellectual Property Office, the disclosure of which is incorporated herein in its entirety by reference.

### TECHNICAL FIELD

The present disclosure relates to a collision avoidance warning system and a method for controlling the same, and more particularly, to a collision avoidance warning system and a method for controlling the same which can warn to avoid a collision with a vehicle when movement means such as bicycles and kickboards are used.

### BACKGROUND

In recent years, various micromobilities such as electric bicycles and kickboards have emerged, and their risks of accidents are increasing rapidly. In the case of the micromobilities, a driver is exposed to the outside, and the risk is very high when an accident occurs.

Meanwhile, large vehicles such as cargo vehicles have a problem in that the passengers of the micromobilities entering in the same environment as alleys are hard to see. In addition, even if the micromobility is found, it is difficult to suddenly reduce the speed because the car is large.

There is a problem in that it is difficult for passengers who are not skilled in the manipulation of the micromobility, such as children to control instantaneously after recognizing the vehicle.

### SUMMARY

The present disclosure has been made in an effort to provide a collision avoidance warning system and a method for controlling the same which can recognize a sudden approach of a vehicle during driving through a wireless transceiving device and warn to avoid a collision with the vehicle through an algorithm when movement means such as bicycles and kickboards are used.

An exemplary embodiment of the present disclosure provides a collision avoidance warning system which includes: a first wireless transceiving device provided in a first movement means; a second wireless transceiving device provided in a second movement means and connected to the first wireless transceiving device by wireless network communication; a control unit provide in the first wireless transceiving device, and deriving a collision risk level of the first movement means and the second movement means; and an alarm transmission unit transmitting a warning alarm to a user of the first movement means according to the collision risk level derived by the control unit.

The second wireless transceiving device includes an application to be connected to the first wireless transceiving device.

When the second wireless transceiving device is positioned within a set distance range based on the first wireless transceiving device, the second wireless transceiving device is connected to the first wireless transceiving device.

The control unit derives the collision risk level by a collision prediction algorithm, and the control unit performs the collision prediction algorithm based on information of the first movement means, information of the second movement means, and environmental information.

The second wireless transceiving device delivers the information of the second movement means to the first wireless transceiving device, and the information of the second movement means includes a GPS and speed information of the second movement means.

The information of the first movement means includes a GPS and speed information of the first movement means.

Another exemplary embodiment of the present disclosure provides a method for controlling a collision avoidance warning system, which includes: a) connecting a first wireless transceiving device provided in a first movement means and a second wireless transceiving device provided in a second movement means by wireless network communication; b) transmitting, by the second wireless transceiving device, information of the second movement means to the first wireless transceiving device; c) deriving, by a control unit in the first wireless transceiving device, a collision risk level with a vehicle through a collision risk level prediction algorithm; and d) transmitting a warning alarm to a user according to the derived collision risk level.

The method further includes, before step b) above is executed, a-1) transmitting, by the first wireless transceiving device, the warning alarm.

Before step c) above is performed, the control unit acquires information of the first movement means and environmental information.

The information of the second movement means transmitted in step b) above includes a GPS and speed information of the second movement means.

The information of the first movement means includes a GPS and speed information of the first movement means.

Details of other embodiments are included in the detailed description and the drawings.

According to exemplary embodiments of the present disclosure, a collision avoidance warning system and a method for controlling the same have the following effects.

First, when a first wireless transceiving device provided in one movement means and a second wireless transceiving device provided in the other movement means are connected, the first wireless transceiving device transmits a warning alarm to recognize that a separate movement means approaches, thereby avoiding accidence occurrence.

Second, information of a movement means is delivered from the second wireless transceiving device connected by wireless communication, and a collision risk level is derived through an internal algorithm to transmit route alarms of different types according to a collision risk level, thereby enabling more secure risk recognition.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual view illustrating an example in which a collision avoidance warning system is applied according to the present disclosure.

FIG. 2 is a block diagram illustrating a configuration of the collision avoidance warning system according to the present disclosure.

FIG. 3 is a block diagram illustrating a method for controlling the collision avoidance warning system according to FIG. 2.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

The drawings are schematic and not illustrated according to a scale. The relative dimensions and ratios of the parts in the drawings are shown in its size for clarity and convenience in the drawing, and are shown in its size, and any dimensions are just exemplary, not limited. In addition, the same reference signs are used to show similar characteristics in the same structure, elements or components that appear in two or more drawings.

The exemplary embodiment of the present disclosure specifically represents an exemplary embodiment of the present disclosure. As a result, various modifications of a diagram are expected. Therefore, the exemplary embodiment is not limited to a specific form of an illustrated region, and for example, also includes a modification of a form by manufacturing.

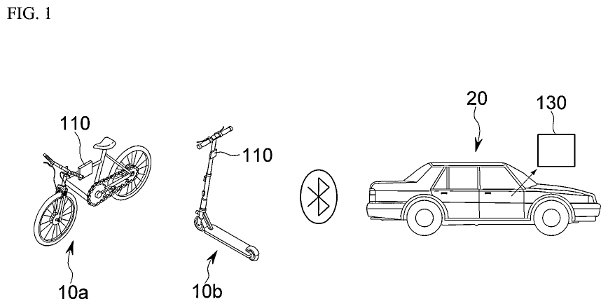

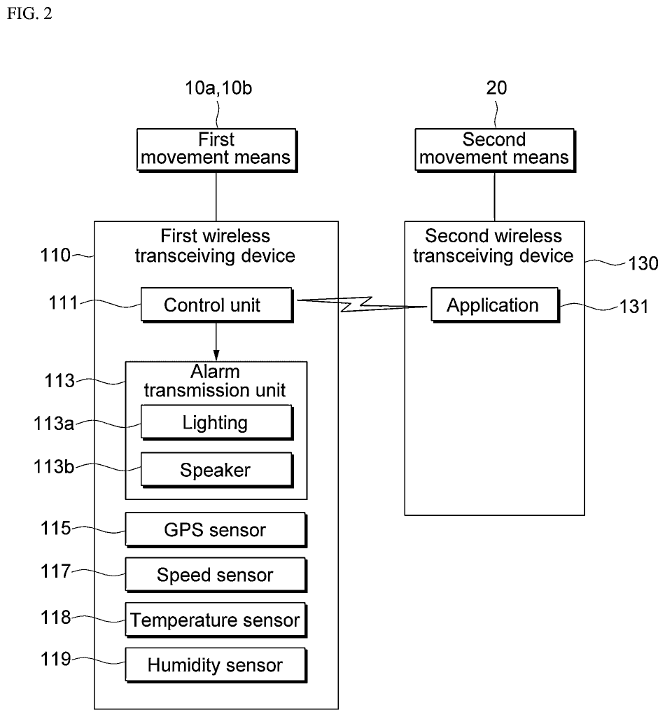

Hereinafter, a collision avoidance warning system and a method for controlling the same according to the present disclosure will be described in detail with reference to FIGS. 1 to 3.

The collision avoidance warning system according to an exemplary embodiment of the present disclosure includes a first wireless transceiving device 110, a second wireless transceiving device 130, a control unit 111, and an alarm transmission unit 113.

The first wireless transceiving device 110 is provided in first movement means 10a and 10b. The first movement means 10a and 10b is a micromobility. The first movement means 10a and 10b includes, for example, an electric bicycle, a kickboard, etc.

The first wireless transceiving device 110 is basically attached to and provided in the first movement means 10a and 10b. However, the first wireless transceiving device 110 is not limited thereto, and while a user who intends to use the first movement means 10a and 10b possesses the first wireless transceiving device 110, the first wireless transceiving device 110 may be provided in the first movement means 10a and 10b. In the exemplary embodiment, a communication dongle is taken as an example of the first wireless transceiving device 110.

The second wireless transceiving device 130 is provided in a second movement means 20. The second movement means 20 is a vehicle.

The second wireless transceiving device 130 is connected to the first wireless transceiving device 110 by wireless network communication. In the exemplary embodiment, exemplarily, the second wireless transceiving device 130 and the first wireless transceiving device 110 are connected by Bluetooth.

When the second wireless transceiving device 130 is positioned within a set distance range based on the first wireless transceiving device 110, the second wireless transceiving device 130 and the first wireless transceiving device 110 are connected by the Bluetooth.

The second wireless transceiving device 130 may be provided in the form of a terminal in the vehicle 20. The second wireless transceiving device 130 includes an application (not illustrated). The application (not illustrated) is software installed in the second wireless transceiving device 130 so that the second wireless transceiving device 130 may perform a transceiving operation with the first wireless transceiving device 110.

The second wireless transceiving device 130 delivers information of the vehicle 20 to the first wireless transceiving device 110. The operation of delivering the information of the vehicle 20 is performed by the application.

The information of the vehicle 20 delivered by the second wireless transceiving device 130 includes a GPS and vehicle speed information of the vehicle 20.

The control unit 111 is provided in the first wireless transceiving device 110. The control unit 111 receives the information of the vehicle 20 delivered by the second wireless transceiving device 130.

The control unit 111 stores a collision risk level prediction algorithm which is capable of predicting collision risk levels of the first movement means 10a and 10b, and the second movement means 20. Therefore, when the control unit 111 receives information of the vehicle 20, the control unit 111 executes the collision risk level prediction algorithm to derive the collision risk level.

However, the collision risk level is not derived only by the information of the vehicle 20, and information of the first movement means 10a and 10b, and environment information and information of the user who uses the first movement means 10a and 10b are required for executing the collision prediction algorithm.

The control unit 111 acquires the information on the first movement means 10a and 10b. Exemplarily, the control unit 111 may acquire the GPS and the speed information of the first movement means 10a and 10b. To this end, a GPS sensor 115 and a speed sensor 117 may be provided in the first movement means 10a and 10b.

The control unit 111 may acquire environmental information and user information. The first movement means 10a and 10b may further include a temperature sensor 118 and a humidity sensor 119. Therefore, the control unit 111 may acquire temperature and humidity information of a situation in which the first movement means 10a and 10b is operated through the temperature sensor 118 and the humidity sensor 119.

The control unit 111 may also acquire information on the user who uses the first movement means 10a and 10b. An input means (not illustrated) capable of inputting the user information who uses the first movement means 10a and 10b may be further provided in the first movement means 10a and 10b. Therefore, when the first movement means 10a and 10b is used, the user may directly input information through the input means (not illustrated).

With respect to a sharing electric bicycle or a sharing kickboard which has been recently generalized, since the user information is input into an application installed in a mobile device of the user, the information of the user who uses the first movement means 10a and 10b may be acquired from the application.

The control unit 111 derives the collision risk level by performing the collision risk level prediction algorithm based on the information of the second movement means 20, the information of the first movement means 10a and 10b, the environmental information, and the user information.

When the control unit 111 derives the collision risk level, the alarm transmission unit 113 transmits a warning alarm for avoiding a collision between the first movement means 10a and 10b and the second movement means 20.

The warning alarm transmitted by the alarm transmission unit 113 transmits a different type of warning alarm according to a range of the collision risk level derived by the control unit 111.

The alarm transmission unit 113 includes a lighting 113a and a speaker 113b. That is, the alarm transmission unit 113 transmits the warning alarm through light and sound. The alarm transmission unit 113 may simultaneously actuate the lighting 113a and the speaker 113b, and actuate the lighting 113a and the speaker 113b separately.

Further, the alarm transmission unit 113 may actuate a color the lighting 113a differently or actuate the form of the sound of the speaker 113b differently according to the range of the collision risk level derived by the control unit 111. This will be described in more detail in a control method to be described below.

Meanwhile, the alarm transmission unit 113 may transmit the alarm even in the case where the first wireless transceiving device 110 and the second wireless transceiving device 130 are connected by the Bluetooth in addition to the case where the control unit 111 derives the collision risk level. Through this, the user who uses the first movement means 10a and 10b may sense that the second movement means 20 is located in the vicinity of the user at the moment when the first wireless transceiving device 110 and the second wireless transceiving device 130 are connected.

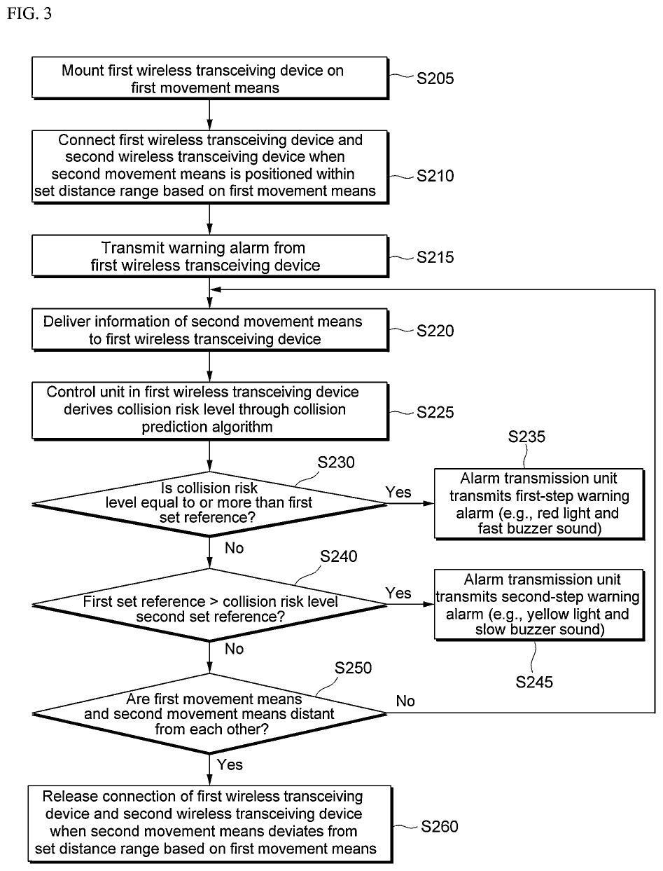

Hereinafter, a method for controlling the collision avoidance warning system according to an exemplary embodiment of the present disclosure will be described with reference to FIG. 3.

In the method for controlling the collision avoidance warning system according to an exemplary embodiment of the present disclosure, first, the first wireless transceiving device 110 is mounted on the first movement means 10a and 10b (step S205). As described above, in the exemplary embodiment, the first wireless transceiving device 110 is applied as the communication dongle. The first wireless transceiving device 110 may be provided in the first movement means 10a and 10b at all times, and the user who intends to the first movement means 10a and 10b may possess the first wireless transceiving device 110.

After step S205 above, the user drives by using the first movement means 10a and 10b. When the second movement means 20 with the second wireless transceiving device 130 is positioned within a set distance range based on the first movement means 10a and 10b during driving of the first movement means 10a and 10b, the first wireless transceiving device 110 and the second wireless transceiving device 130 are connected (step S210).

Specifically, while the application (not illustrated) of the second movement means 20 is executed, the second wireless transceiving device 130 is connected to the first wireless transceiving device 110. In this case, the first wireless transceiving device 110 is connected to the second wireless transceiving device 130 by Bluetooth (wireless network communication).

When the first wireless transceiving device 110 is connected to the second wireless transceiving device 130, the warning alarm is transmitted from the first wireless transceiving device 110 (step S215). In this case, the warning alarm transmitted by the first wireless transceiving device 110 serves to announce that the second movement means 20 is located at a short distance of the first movement means 10a and 10b.

When the first wireless transceiving device 110 is connected to the second wireless transceiving device 130, the second wireless transceiving device 130 delivers the information of the second movement means 20 to the first wireless transceiving device 110 (step S220). Specifically, the information of the second movement means 20 is the GPS of the second movement means 20 and the speed of the second movement means 20.

The information of the second movement means 20 is received by the control unit 111. In addition, the control unit 111 derives a collision risk level of the first movement means 10a and 10b and the second movement means 20 through a prestored collision prediction algorithm (step S225).

Meanwhile, the control unit 111 acquires the information on the first movement means 10a and 10b in order to execute the collision prediction algorithm. In this case, the information acquired by the control unit 111 is the GPS information and the speed information which are the information of the first movement means 10a and 10b, and the temperature and humidity information which is the environmental information. Further, gender and age information which is the information of the user who uses the first movement means 10a and 10b may be further acquired.

The control unit 111 executes the collision prediction algorithm based on the information of the second movement means 20, the information of the first movement means 10a and 10b, the temperature and humidity information, and the gender and age information of the user. Specifically, the information of the second movement means 20, the information of the first movement means 10a and 10b, the temperature and humidity information, and the gender and age information of the user are input as an input value, so when the collision prediction algorithm is executed, the collision risk level is derived as an output value.

When the collision risk level is derived in step S225 above, the derived collision risk level and a first set reference are compared (step S230). Here, when it is determined that the collision risk level is equal to or more than the first set reference, the control unit 111 controls the alarm transmission unit 113 to transmit a first-step warning alarm (step S235).

In the exemplary embodiment, when the collision risk level is equal to or more than the first set reference, it is determined that the collision risk level between the first movement means 10a and 10b and the second movement means 20 is a very high level. Therefore, the first-step warning alarm should announce that a collision risk is high to the user. In the exemplary embodiment, in the case of the first-step warning alarm, red light is irradiated from the lighting 113a, and a fast buzzer sound is transmitted from the speaker 113b. However, the red light or the fast buzzer sound is limited to the exemplary embodiment, so is not limited thereto, but may be variously changed.

Meanwhile, if the derived collision risk level is not equal to or more than the first set reference, it is determined that the collision risk level is less than the first set reference and included within a range equal to or more than a second set reference (step S240).

Here, when it is determined that the derived collision risk level is less than the first set reference and included within a range equal to or more than the second set reference, the control unit 111 controls the alarm transmission unit 113 to transmit a second-step warning alarm (step S245).

When the collision risk level is less than the first set reference and included in the range more than the second set reference, it is determined that the collision risk is lower than the collision risk when the collision risk level is equal to or more than the first set reference. Therefore, the alarm transmission unit 113 transmits a warning alarm different from the first-step warning alarm so that the user may recognize a situation different from the situation when the collision risk level is equal to or more than the first set reference.

In the exemplary embodiment, in the case of the second-step warning alarm, yellow light is irradiated from the lighting 113a, and a slow buzzer sound is transmitted from the speaker 113b. The second-step warning alarm is also just limited to the exemplary embodiment, so the second-step warning alarm may be variously changed.

Meanwhile, when it is determined that the collision risk level is less than the first set reference and not included in the range equal to or more than the second set reference in step S240 above, it is determined whether the first movement means 10a and 10b and the second movement means 20 are distant from each other (step S250).

When it is determined that the first movement means 10a and 10b and the second movement means 20 are not distant from each other in step S250 above, the process returns to step S220 above. As a result, the control unit 111 repeatedly performs steps S220 to S240 above.

Meanwhile, when it is determined that the first movement means 10a and 10b and the second movement means 20 are distant from each other in step S250 above, the control unit 111 controls the alarm transmissions unit 113 to be not actuated. In addition, when the second movement means 20 deviates from the set distance range based on the first movement means 10a and 10b, the connection of the first wireless transceiving device 110 and the second wireless transceiving device 130 are released.

When the collision avoidance warning system and the method for controlling the same are used, the approach of the vehicle may be known at the time of using the movement means such as the electric bicycle and the kickboard, the collision with the vehicle may be prevented.

The collision risk level with the second movement means (vehicle) is derived from the first wireless transceiving device provided in the first movement means (electric bicycle and kickboard), and the resulting warning alarm is transmitted, so the user of the first movement means may avoid the collision with the second movement means and safely use the first movement means.

Hereinabove, the embodiments of the present disclosure have been described with the accompanying drawings, but it can be understood by those skilled in the art that the present disclosure can be executed in other detailed forms without changing the technical spirit or requisite features of the present disclosure.

Therefore, the embodiments described as above are exemplary in all aspects and should be understood as not being restrictive and the scope of the present disclosure is represented by claims to be described below, and it is to be interpreted that the meaning and scope of the claims and all the changes or modified forms derived from the equivalents thereof come within the scope of the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A collision avoidance warning system comprising:
a first wireless transceiving device provided in a first movement means;
a second wireless transceiving device provided in a second movement means and connected to the first wireless transceiving device by wireless network communication;
a control unit provide in the first wireless transceiving device, and deriving a collision risk level of the first movement means and the second movement means; and
an alarm transmission unit transmitting a warning alarm to a user of the first movement means according to the collision risk level derived by the control unit.

2. The collision avoidance warning system of claim 1, wherein the second wireless transceiving device includes an application to be connected to the first wireless transceiving device.

3. The collision avoidance warning system of claim 2, wherein when the second wireless transceiving device is positioned within a set distance range based on the first wireless transceiving device, the second wireless transceiving device is connected to the first wireless transceiving device.

4. The collision avoidance warning system of claim 1, wherein the control unit derives the collision risk level by a collision prediction algorithm, and
the control unit performs the collision prediction algorithm based on information of the first movement means, information of the second movement means, and environmental information.

5. The collision avoidance warning system of claim 4, wherein the second wireless transceiving device delivers the information of the second movement means to the first wireless transceiving device, and
the information of the second movement means includes a GPS and speed information of the second movement means.

6. The collision avoidance warning system of claim 4, wherein the information of the first movement means includes a GPS and speed information of the first movement means.

7. A method for controlling a collision avoidance warning system, the method comprising:
a) connecting a first wireless transceiving device provided in a first movement means and a second wireless transceiving device provided in a second movement means by wireless network communication;
b) transmitting, by the second wireless transceiving device, information of the second movement means to the first wireless transceiving device;
c) deriving, by a control unit in the first wireless transceiving device, a collision risk level with a vehicle through a collision risk level prediction algorithm; and
d) transmitting a warning alarm to a user according to the derived collision risk level.

8. The method of claim 7, further comprising:
before step b) above is executed,
a-1) transmitting, by the first wireless transceiving device, the warning alarm.

9. The method of claim 7, wherein before step c) above is performed, the control unit acquires information of the first movement means and environmental information.

10. The method of claim 7, wherein the information of the second movement means transmitted in step b) above includes a GPS and speed information of the second movement means.

11. The method of claim 9, wherein the information of the first movement means includes a GPS and speed information of the first movement means.
